(19) United States
(12) Patent Application Publication
(10) Pub. No.: US 2013/0167386 A1
(43) Pub. Date: Jul. 4, 2013

(54) OPTICAL LEVELING INSTRUMENT WITH CENTRAL COMMON POINT CONSOLIDATION STRUCTURE

(71) Applicant: Ke-Ou PENG, Taipei City (TW)

(72) Inventor: Ke-Ou PENG, Taipei City (TW)

(21) Appl. No.: 13/338,969

(22) Filed: Dec. 28, 2011

(51) Int. Cl. G01C 5/00

(52) U.S. Cl. 33/290

(57) ABSTRACT

The present invention provides an optical leveling instrument with central common point consolidation structure, and more particularly the center of working indicator light beams meet at the center of rotation point of two axes of toggle movement to serve as a central common point of center of rotation. During the stopping process, no height difference occurs in the directional light beams emitted by the instrument. The optical leveling instrument comprises a universal toggle support, and two horizontal working axes thereof intersect in the same plane and serves as the central common point of center of rotation. Moreover, centers of directional light beams emitted by a set of light emitting modules to collectively form the central common point of center of rotation.

### BACKGROUND OF THE INVENTION

(a) Field of the Invention

An optical leveling instrument with central common point consolidation structure, which provides an optical leveling instrument able to prevent a height difference from occurring in the emitted plane directional light beams during the stopping process, and is able to rapidly balance the directions.

(b) Description of the Prior Art

Horizontal thin directional light and toggle support device of the movement weight mechanism of current common leveling instruments are not in plane. During the process of stopping swinging, variations in the height of the horizontal thin directional light for directional leveling (as depicted in FIGS. 1 and 2) occur. Similarly, during the process of stopping swinging, transverse displacement will occur in the vertical thin directional light. Such displacements cause difficulties in fixing position of the horizontal height and fixing left-right position of the vertical line during use. In common automatic leveling instruments, the optical horizontal plane is not at the center of rotation of a universal rotating platform. When the optical surface deviates from the balance position, height of the center of the optical surface changes along with changes in angular deviation (as depicted in FIG. 1).

Referring to FIG. 3, which depicts a leveling instrument of Taiwan patent application No. I264526, which uses a suspending body 102, and the main body of the suspending body 102 is fitted with a vertical and horizontal laser transmitting unit 103. The upper portion of the suspending body 102 is coupled to a toggle support device 101 so as to assume a plane vertical at different heights, and uses the effect of the suspending body 102 to obtain a horizontal angle position. Based on the aforementioned design, a vertical displacement of a horizontal thin directional light 400 is formed similar to the eccentric swinging depicted in FIG. 1.

Referring to FIG. 4, which shows Taiwan patent No. M303366, in which a laser transmitting unit 103 is fitted to the upper end of a toggle support device 101, and the lower portion of the laser transmitting unit 103 is coupled to a suspending body 102. The suspending body 102 uses its dead weight relative to gravitational effect to cause the laser transmitting unit 103 to obtain angular positioning of a horizontal laser. Similar to the eccentric swinging state of FIG. 2, the design of the suspending body 102 causes variation in height of the laser transmitting unit 103 by way of the pivot function of the toggle support device 101. Similarly, considerable eccentric swinging is correspondingly caused in a vertical thin directional light 500. Because a radius length is provided between the toggle support device 101 and the laser transmitting unit 103, thus, the variation in angular position produced after the leveling instrument has been stopped makes it relatively difficult to achieve a balanced state. Hence, the present invention provides a system based on a central common point serving as a center of rotation, thereby enabling rapid balancing to be achieved and obtaining a horizontal or vertical operating point.

### SUMMARY OF THE INVENTION

A primarily objective of the present invention lies in an optical leveling instrument with central common point consolidation structure, which provides an optical leveling instrument able to prevent height difference from occurring in the emitted plane directional light beams during the stopping process, and is able to rapidly balance the directions. Intersection of two axes on the same plane and at equal height positions of a universal toggle support is used to form a central common point of center of rotation. In addition, the center of plane directional light also meets at the position of the central common point, thereby enabling rapid balancing and preventing intense variation in the amplitudes of oscillation of directional light during the stopping process. Another objective of the present invention lies in the stimulated directional light being provided with a horizontal and vertical directive function.

A third objective of the present invention lies in light emitting modules using laser fan-shaped optical emitters having a cylinder effect to serve as the laser sources, and an equal division method is adopted to collectively construct thin optical planes.

A fourth objective of the present invention lies in a swinging rod, a balance weight at the lower end of which, as a minimum, does not have magnetic attraction, and a stopping operation is effected when subjected to vortex flows produced by a closed circuit loop of a magnetic flux sealer.

A fifth objective of the present invention lies in the material used to construct the leveling instrument, wherein apart from the magnetic flux sealer system, and, in principle, material not having a magnetic attraction effect is used, such as copper, aluminum, carbon fiber compounds, and the like.

A sixth objective of the present invention lies in the magnetic flux sealer being provided with a circuit loop function, and permanent magnets used in the instrument are strongly magnetic.

A seventh objective of the present invention lies in the waist portion of the swinging rod being fitted with a retaining device corresponding to the waist portion of a pedestal, and the retaining device produces a scissor pressure which acts radially on the swinging rod. The retaining device comprises a driving arm and a driven arm, and actuating one of the arms changes the scissor angle, moreover storing away is facilitated.

To enable a further understanding of said objectives and the technological methods of the invention herein, a brief description of the drawings is provided below followed by a detailed description of the preferred embodiments.

### BRIEF DESCRIPTION OF THE DRAWINGS

FIG. 1 is a schematic view depicting eccentric swinging of the prior art, in which the lower end of a pendulum is fitted with a laser transmitting unit.

FIG. 2 is a schematic view depicting eccentric swinging produced by the prior art, in which the upper end of a suspending body is fitted with a laser transmitting unit by means of a toggle support device.

FIG. 3 is a schematic view of a horizontal leveling instrument of Taiwan patent No. I246526.

FIG. 4 is a side view of a horizontal leveling instrument of Taiwan patent No. M303366.

FIG. 5 is a schematic view of the external appearance of the present invention depicting production of a horizontal thin directional light and a vertical thin directional light.

FIG. 6 is a schematic view depicting the mechanical components of the interior of a pedestal of the present invention.

FIG. 7 is a schematic view of the present invention depicting production of fan-shaped horizontal thin directional light and vertical thin directional light after a horizontal thin light emitting module and a vertical thin light emitting module are joined to form an optical emitter.

FIG. 8 is a schematic view depicting the basic structure of the present invention, in which the horizontal thin light emitting module and the vertical thin light emitting module are assembled to the upper end of the pedestal.

FIG. 9 is a schematic view of a side view depicting automated effectiveness of the present invention.

FIG. 10 is a schematic view depicting the automation principle of the present invention, in which a balance weight fitted to a swinging rod is subjected to vortex flow of a magnetic flux sealer.

FIG. 11 is a schematic view depicting the present invention, in which the pedestal is fitted with a retaining device to form mechanical pressure fixing of the swinging rod.

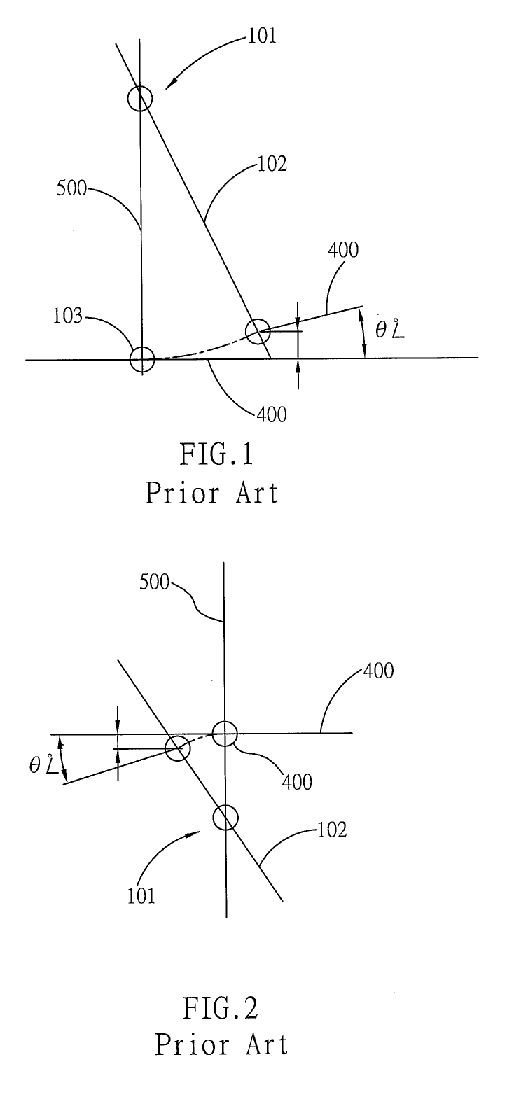

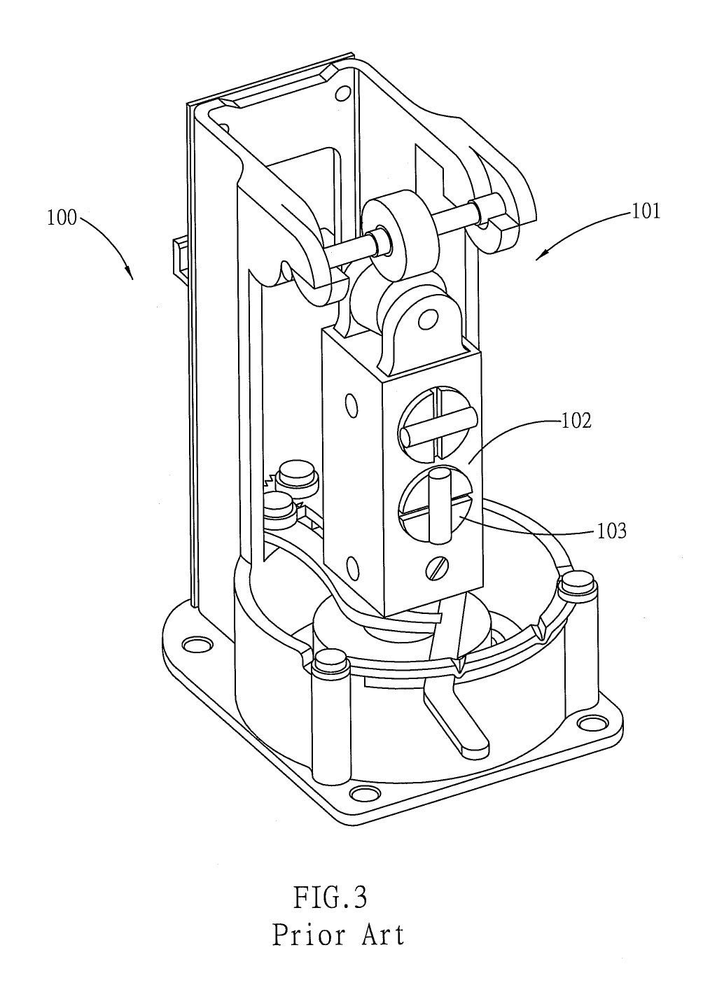

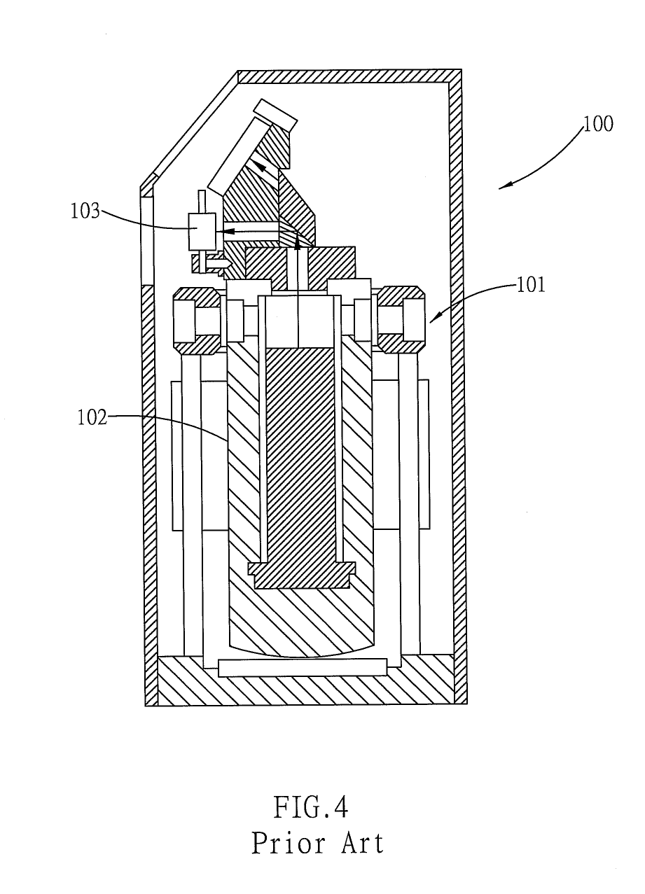

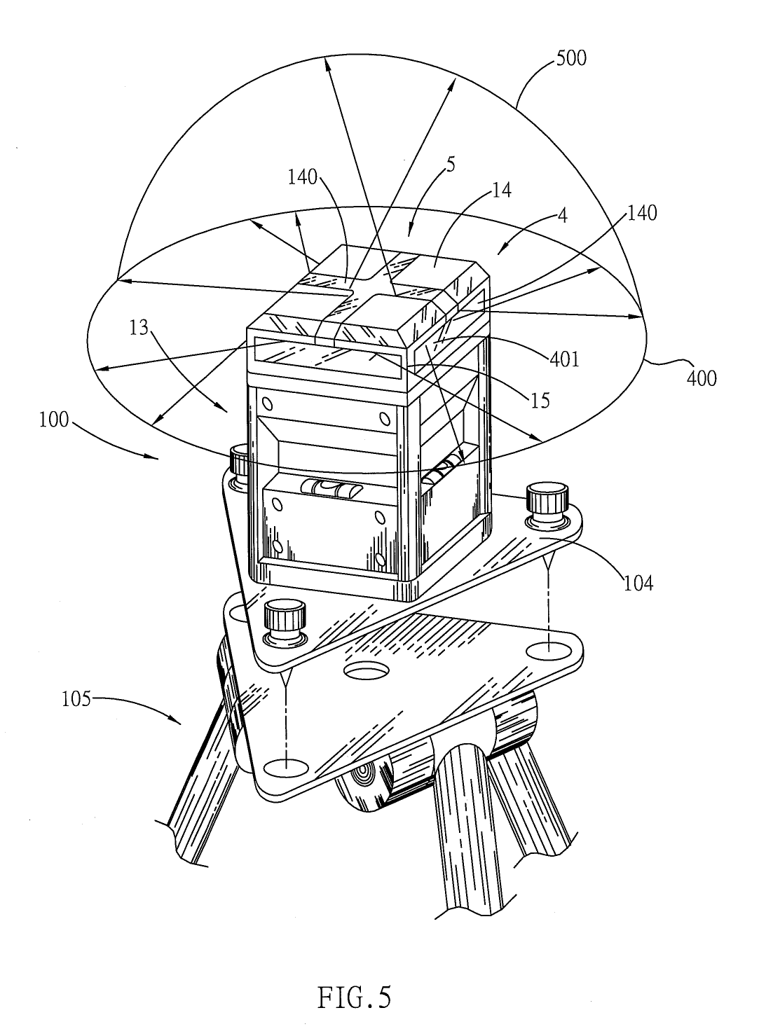

### DETAILED DESCRIPTION OF THE PREFERRED EMBODIMENTS

The present invention provides an optical leveling instrument, in which rotation within the interior of the system is based around a central common point serving as the center, and rapidly balancing of directional light beams is achieved through a consolidated common center point design.

Through the common center point of center of rotation, an optical plane surface of the present invention enables the height of the horizontal plane center of horizontal thin directional light to be consistent with the height of the balance position, thereby simplifying height adjustment of the leveling instrument. The present invention maintains the height of the horizontal thin directional light height, as well as ensuring there is no displacement during the stopping process of the vertical thin directional light.

A general semiconductor laser contains a ferromagnetic component, and generally uses a movement weight to cut and open the magnetic lines of force produced by permanent magnets to produce a vortex flow and achieve the objective of stopping. When strong permanent magnets are used to speed up stopping of swinging, a laser suspended in the movement weight is subjected to the effect of opened up magnetic lines of force and reduces precision. Such an error becomes even more evident as the tilt angle increases. However, when the present invention uses strong magnets, the user is able to maintain measuring accuracy even when the tilt angle is large.

The operational principle and component composition of the present invention will become apparent upon reading the following description of the embodiments with the accompanying drawings.

Referring first to FIG. 5, which shows a leveling instrument 100 of the present invention, which is a laser optical horizontal directional instrument able to emit a horizontal thin directional light 400 or simultaneously emit a vertical thin directional light 500. The leveling instrument 100 is fitted with a cover member 14, and the upper end of the cover member 14 emits the horizontal thin directional light 400 and the vertical thin directional light 500. The horizontal thin directional light 400 and the vertical thin directional light 500 are respectively emitted from a horizontal thin light emitting module 4 and a vertical thin light emitting module 5 fitted in the interior of the upper end of a casing 13. The optical paths pass through a plurality of windows 140 of the cover member 14. The paths of the horizontal thin directional light 400 respectively cross connecting columns 15, and the connecting columns 15 are positions of dark spaces 401. Hence, flat fan-shaped light beams emitted from four directions are able to combine to form the all-round horizontal thin directional light 400.

A lower portion of the casing 13 is fitted with a base plate 104, and the base plate 104 enables increasing height position by means of the support of an auxiliary frame 105. The leveling instrument 100 can be regarded as an independent body.

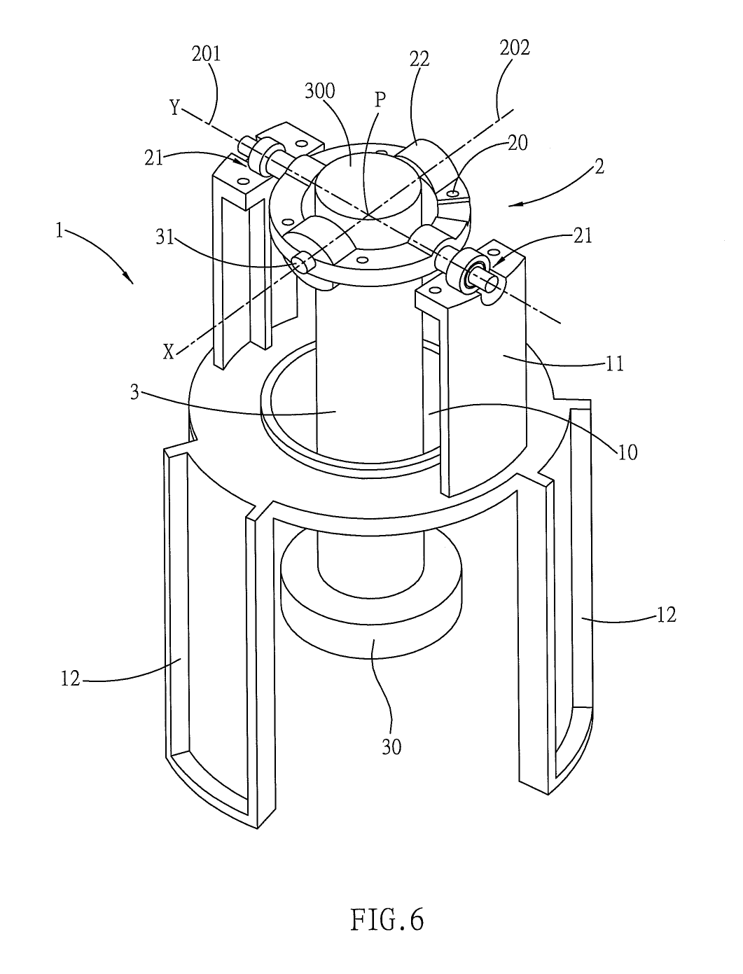

Referring to FIG. 6, the internal mechanism of the present invention comprises a pedestal 1, a lower end of the pedestal 1 is fitted with feet supports 12, and the upper portion is fitted with two mutually facing support columns 11. Mutually facing plane surfaces at the upper ends of the support columns 11 are fitted with two symmetrical pivots 21. Center lines of the two mutually facing pivots 21 form a rotating first horizontal axes 201, and the pivots 21 are connected to a universal toggle support 2. The universal toggle support 2 is annular shaped, and is fitted with pin connecting mounts 22 which assume perpendicular angular positions in the same plane with the first horizontal axis 201, and the center lines of the pin connecting mounts 22 form the second horizontal axis 202. The second horizontal axis 202 and the first horizontal axis 201 are at equal height in the same plane, and a virtual intersection thereof forms a central common point P of center of rotation.

In addition, the pin connecting mounts 22 are connected to the upper end of a swinging rod 3 by means of opposing shafts 31, and the swinging rod 3 is located in the vertical space of a hollowed out portion 10 of the pedestal 1. The lower portion of the main body of the swinging rod 3 hangs downward, and the bottom portion of the swinging rod 3 is joined to a balance weight 30. The upper end of the swinging rod 3 forms a horizontal reference portion 300 to enable the assembly of external devices, and the axis of the swinging rod 3 intersects the aforementioned central common point P.

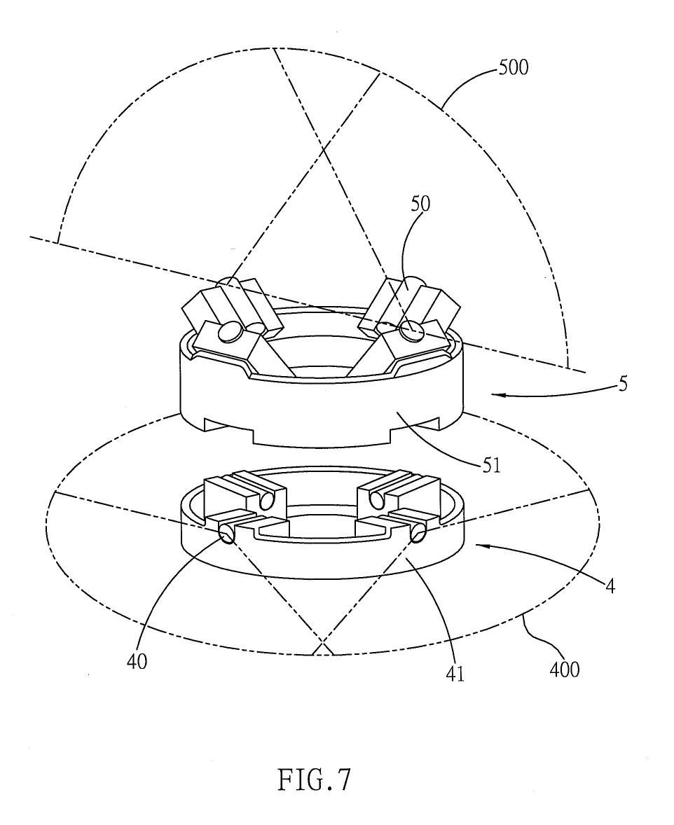

Referring to FIG. 7, the horizontal thin directional light 400 and the vertical thin directional light 500 produced by the present invention are emitted by the horizontal thin light emitting module 4 and the vertical thin light emitting module 5 respectively.

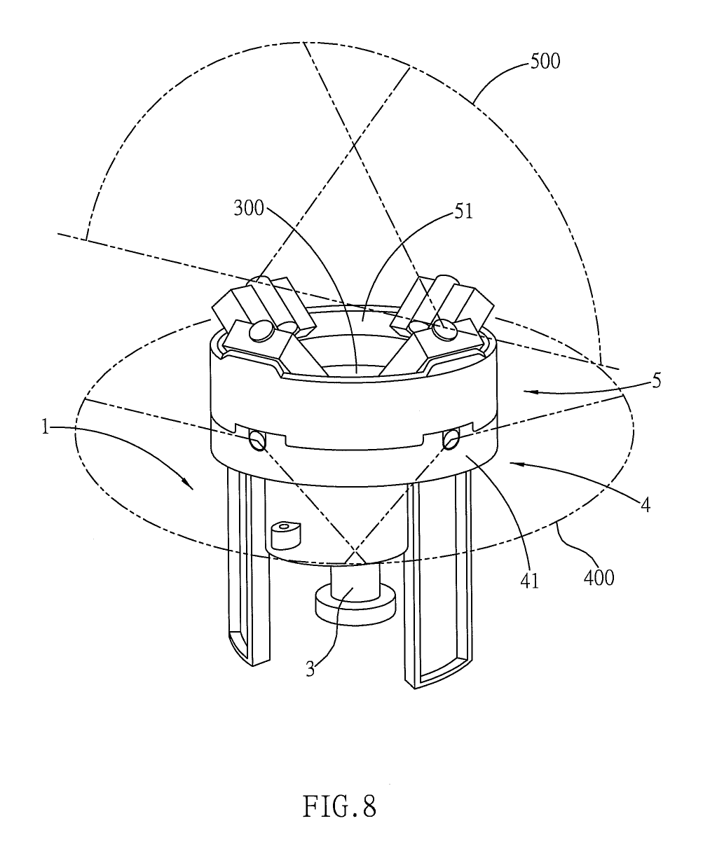

The horizontal thin light emitting module 4 comprises a base 41 assembled with a plurality of fan-shaped optical emitters 40, and each of the fan-shaped optical emitters 40 radiate a fan-shaped horizontal thin directional light 400 of equal center angle. The vertical thin light emitting module 5 similarly comprises one or more than two fan-shaped optical emitters 50 assembled to a coupling mount 51, and the vertical thin directional light 500 emitted by the vertical thin light emitting module 5 can span 180 degrees. The vertical thin light emitting module 5 is preferably assembled to the upper portion of the horizontal thin light emitting module 4. The integrated unit after assembly is as depicted in FIG. 8, and is directly or indirectly bridge joined to the position of the horizontal reference portion 300 at the upper end of the swinging rod 3 connected to the pedestal 1. Moreover, the horizontal thin directional light 400 assumes a perpendicular relationship to the vertical thin directional light 500, and the central points of the two thin directional lights 400, 500 together meet at the central common point P, as depicted in FIG. 6. Hence, because the produced center of rotation is retained, thus, the planar centers of the horizontal thin directional light 400 and the vertical thin directional light 500 emitted by the horizontal thin light emitting module 4 and the vertical thin light emitting module 5 respectively will meet at the central common point P. Position of the consolidation structure of the center of rotation at the central common point P is used to enable the horizontal thin directional light 400 and the vertical thin directional light 500 to quickly achieve a balanced state when subjected to an external stopping force.

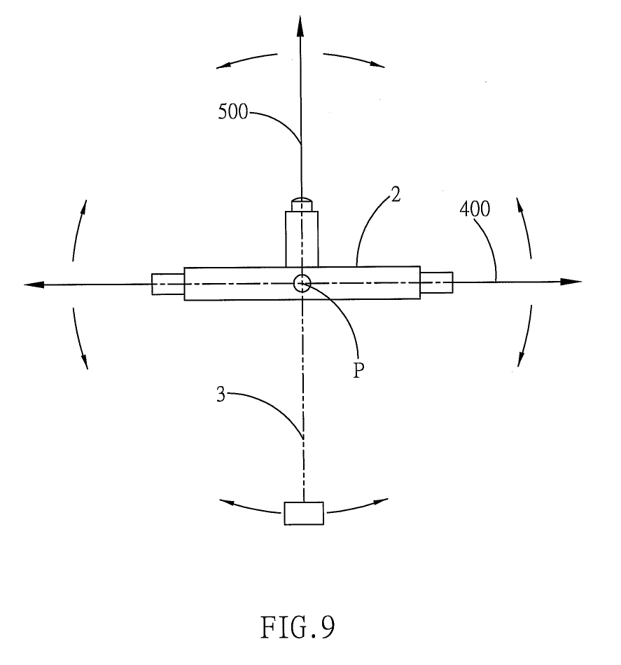

Referring to FIG. 9, when the swinging rod 3 is subjected to an external force which produces eccentric swinging, because the center of rotation of the horizontal thin directional light 400 and the vertical thin directional light 500 meet at the same spot at the central common point P in the interior of the universal toggle support 2, thus, rotation or swinging of the horizontal thin directional light 400 and the vertical thin directional light 500 is based only on the central common point P serving as the central driving point. In addition, the swinging rod 3 is subject to the direction of the force of gravity, which enables the horizontal thin directional light 400 and the vertical thin directional light 500 to rapidly achieve a state of balance, thereby rapidly obtaining a definite horizontal orientated direction.

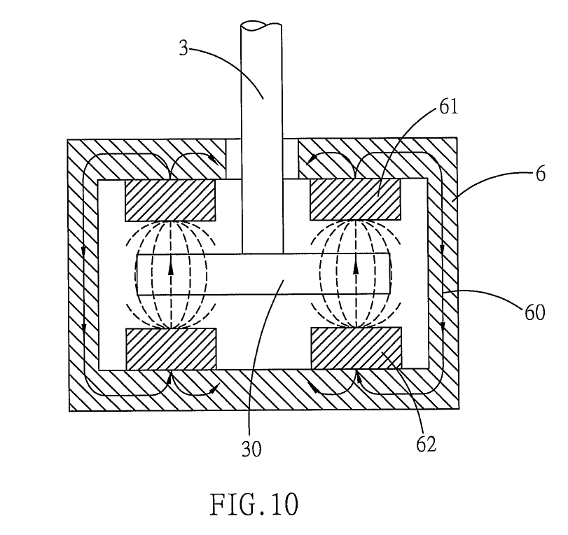

Referring to FIG. 10, the balance weight 30 is joined to the lower end of the swinging rod 3 of the present invention, and, in principle, the balance weight 30 has, as a minimum, no magnetic attraction effect. However, the balance weight 30 is subjected to the vortex flows produced by the function of the magnetic forces between two points of upper and lower mutually directly-facing permanent magnets 61 and permanent magnets 62, which have the effect of impeding rapid halting of the balance weight 30.

A magnetic flux sealer 6 comprises the two upper and lower permanent magnets 61, 62 disposed at positions above and below the upper and lower surfaces of the balance weight 30 respectively. The magnetic field vortex lines produced by the upper and lower permanent magnets 61, 62 are refluxed by being conducted through a circuit loop 60 provided in the periphery of the magnetic flux sealer 6, thereby forming closed circuit loops of vortex flow lines. At which time the magnetic effect of the permanent magnet 61 or the permanent magnet 62 will not affect the other components of the instrument, in particular, will not affect the light emitting modules. Hence, strong magnetic materials of relatively high gauss levels can be adopted for the permanent magnets 61, 62, and the circuit loop 60 is made from soft iron of transient magnetism, which is able to guide and link the magnetic fields of the two permanent magnets 61, 62 to from closed circuit looped force fields.

In the system, apart from the balance weight 30 having no magnetic attraction effect, the other components collectively comprising the structure can similarly be made from material having no magnetic attraction effect, such as copper or aluminium, thereby reducing the magnetic attraction effect of the permanent magnets 61, 62 affecting optical operation or variation in angular position produced by magnetic attraction.

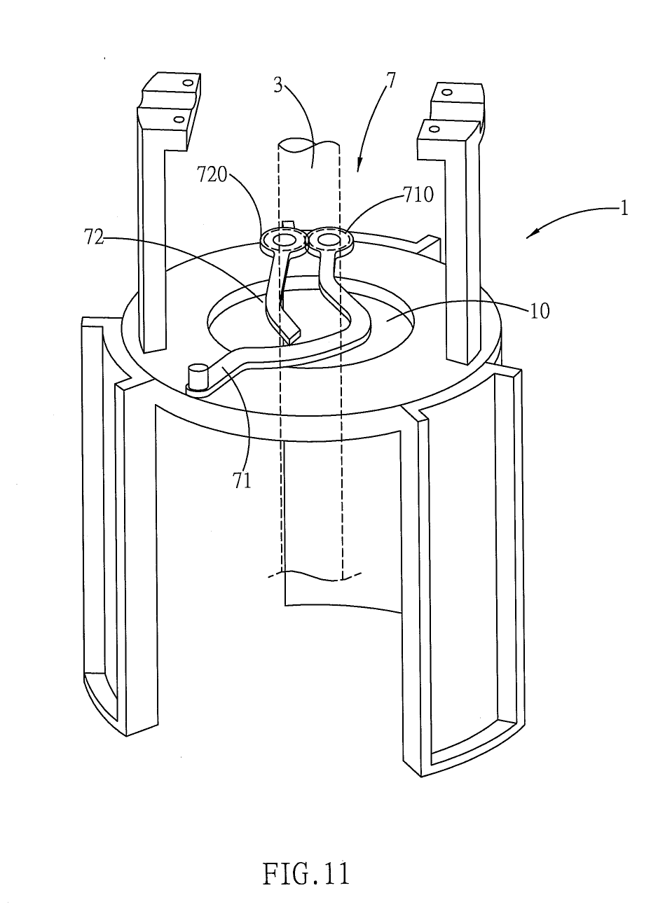

Referring to FIG. 11, the waist position of the hollowed out portion 10 within the pedestal 1 of the present invention corresponds to the waist portion of the swinging rod 3, and the pedestal 1 is fitted with a retaining device 7 which radially surrounds the periphery of the swinging rod 3 to achieve fixing thereof by scissor pressure means. Functionality of the retaining device 7 is produced by mutual pressing of a driven arm 72 and a driving arm 71. Other ends of the driven arm 72 and the driving arm 71 are connected to high positions of the waist of the pedestal 1, and the driven arm 72 can be simultaneously driven through actuation of the driving arm 71 to effect reverse open-close movements. When effecting a closing movement, shearing pressures of the driven arm 72 and the driving arm 71 are directed towards the axial center of the swinging rod 3, thereby fixing the periphery of the swinging rod 3 using shearing pressure. The retaining device 7 is a single operation device, whereby actuating the driving arm 71 enables achieving an open-close movement. Pin joint points of the driving arm 71 and the driven arm 72 are fitted with mutually meshing gears 710, 720 of equal diameter. Through mutual meshing of the gears 710, 720 effecting a change in angular position, movement of one gear causes a reverse direction movement through an identical angle in the other gear, thereby achieving single operation and causing the driven arm 72 and the driving arm 71 to simultaneously form an open-close scissor movement. Furthermore, the retaining device 7 enables mechanically fixing position of the swinging rod 3 when storing away the leveling instrument.

The present invention provides a special design of rotating axes serving to form a central common point, thereby enabling the mechanism of the system or the directional light produced to form a common center point of rotation based on a central common point after movement by an external force to enable the directional light to rapidly achieve balance. The present invention is a completely new design not seen in the prior art, providing convenience of use. Accordingly, a new patent application is proposed herein.

It is of course to be understood that the embodiments described herein are merely illustrative of the principles of the invention and that a wide variety of modifications thereto may be effected by persons skilled in the art without departing from the spirit and scope of the invention as set forth in the following claims.

What is claimed is:

1. An optical leveling instrument with central common point consolidation structure, comprising:
a pedestal provided with a vertical hollowed out portion, wherein the horizontal plane of the upper end of the pedestal is fitted with connecting pivot mounts;
a universal toggle support, wherein a swinging rod is connected and suspends from a center of the universal toggle support, a first horizontal axis and a second horizontal axis which assumes a 90 degree angle with the first horizontal axes are formed based on the configuration of the universal toggle support, intersection of the first horizontal axis and the second horizontal axis forms a central common point at the center and in the same plane of the universal toggle support; two ends of the first horizontal axis respectively assume a connective relationship with the connecting pivot mount;
a horizontal light emitting module, wherein the horizontal light emitting module is relationally joined to the upper end of the swinging rod, and centers of emitted horizontal thin directional light overlap and coincide at the central common point.

2. The optical leveling instrument with central common point consolidation structure according to claim 1, wherein a vertical thin light emitting module is additional fitted above the horizontal thin light emitting module, the planar centers of vertical thin directional light emitted by the vertical thin light emitting module superimpose at the central common point.

3. An optical leveling instrument with central common point consolidation structure, comprising:
a pedestal provided with a vertical hollowed out portion, wherein two sides of the upper end of the pedestal are fitted with pivot mounts mutually facing along a first horizontal axis;
a universal toggle support, wherein the universal toggle support is fitted with toggle joints, the toggle joints pass through two horizontal symmetrical pivot holes, and two pivots respectively pin connect the pivot mounts through the two pivot holes, two mutually facing pin connecting mounts are further fitted on the axis of the toggle joint assuming a 90 degree angle in the same plane with the axis through the two pivot holes, the two mutually facing pin connecting mounts form a second horizontal axis; the second horizontal axis and the first horizontal axis are in the same horizontal plane and intersect to form a central common point;
a swinging rod, wherein the lower end of the swinging rod is fitted with a balance weight, the upper end of the swinging rod is connected to the two pin connecting mounts through opposing shafts;
a horizontal thin light emitting module, wherein the horizontal thin light emitting module is assembled to the upper end of the swinging rod, the virtual center formed by horizontal thin directional light and the central common point form a consolidated single point.

4. The optical leveling instrument with central common point consolidation structure according to claim 3, wherein a vertical thin light emitting module is additionally fitted vertically above the horizontal thin light emitting module, the vertical thin directional light emitted by the vertical thin light emitting module is vertically superimposed on the central common point.

5. The optical leveling instrument with central common point consolidation structure according to claim 3, wherein the upper end of the swinging rod is fitted with a horizontal reference portion, and either the horizontal thin light emitting module or the vertical thin light emitting module is assembled to the horizontal reference portion.

6. The optical leveling instrument with central common point consolidation structure according to claim 3, wherein the horizontal thin light emitting module uses at least one fan-shaped optical emitter to emit horizontal thin directional light.

7. The optical leveling instrument with central common point consolidation structure according to claim 3, wherein the horizontal thin light emitting module uses at least more than two fan-shaped optical emitters to separately emit fan-shaped light beams of equal central angle.

8. The optical leveling instrument with central common point consolidation structure according to claim 4, wherein the vertical thin light emitting module uses at least one fan-shaped optical emitter to emit vertical thin directional light.

9. The optical leveling instrument with central common point consolidation structure according to claim 4, wherein the vertical thin light emitting module uses at least more than two fan-shaped optical emitters, and the at least more than two fan-shaped optical emitters are planar assembled to enable emitting a vertical thin directional light spanning an angle of at least 180 degrees.

10. The optical leveling instrument with central common point consolidation structure according to claim 3, wherein a magnetic flux sealer is fitted at a lower portion of the pedestal corresponding to the position of the stopping space of the balance weight of the swinging rod, the magnetic flux sealer comprises a set of upper and lower mutually facing permanent magnets, the magnetic lines of force of the magnets vertically pass through the balance weight, the magnetic flux sealer on the periphery of the two sets of upper and lower permanent magnets is made from soft iron provided with magnetism and forms a circuit loop conducting magnetic flux lines around the periphery of the two sets of upper and lower permanent magnets.

11. The optical leveling instrument with central common point consolidation structure according to claim 3, wherein a lower portion of the swinging rod is fitted with the balance weight, and the balance weight has, as a minimum, no magnetic force effect.

12. The optical leveling instrument with central common point consolidation structure according to claim 3, wherein material used for the pedestal, the horizontal thin light emitting module, the vertical thin light emitting module and the swinging rod, has, as a minimum, no magnetic force effect.

13. The optical leveling instrument with central common point consolidation structure according to claim 3, wherein the waist portion of the pedestal is fitted with a retaining device so as to radially surround the periphery of the main body of the swinging rod, and the retaining device comprises a driving arm and a driven arm configured so as to act in opposition towards the center point of the swinging rod, thereby enabling the exterior of the main body of the swinging rod to be clamped using scissor pressure means.
